(19) United States
(12) Patent Application Publication
(10) Pub. No.: US 2013/0076308 A1
(43) Pub. Date: Mar. 28, 2013

(54) ARRANGEMENT FOR A CHARGER

(71) Applicants: Timo Niskala, Espoo (FI); Mikko Koskinen, Helsinki (FI); Maija Itkonen, Helsinki (FI); Peter Sazonov, Helsinki (FI)

(72) Inventors: Timo Niskala, Espoo (FI); Mikko Koskinen, Helsinki (FI); Maija Itkonen, Helsinki (FI); Peter Sazonov, Helsinki (FI)

(73) Assignee: POWERKISS OY, Helsinki (FI)

(21) Appl. No.: 13/701,681

(22) PCT Filed: Jun. 3, 2010
(86) PCT No.: PCT/FI2010/050457

§ 371 Date: Dec. 3, 2012

(51) Int. Cl. H05B 37/00; H01F 38/14; H02J 7/00

(52) U.S. Cl. CPC H05B 37/00; H02J 7/0052; H02J 7/00; H01F 38/14
USPC 320/108; 320/137; 307/104; 315/70

(57) ABSTRACT

The invention relates to an indication device, comprising means for receiving magnetic energy and means for transforming said received magnetic energy into light.

### FIELD OF THE INVENTION

The invention relates to a charging method and apparatus, and more particularly to an arrangement for a wireless charger.

### BACKGROUND OF THE INVENTION

In a wireless charging a power surface is provided comprising one or more energy transfer units or transmitters by means of which a charging current may be supplied to a terminal device or a receiver on the surface. For the system to function efficiently, it is important that the transmitter of energy and the receiver of energy are not misplaced in relation to each other. If this happens, the charging is inefficient or even worse, no charging occurs. This is due to the fact that a magnetic field of a primary side, i.e. of the energy transmitting side does not reach magnetic receiving elements of a secondary side, i.e. of the energy receiving side. The accurate placing becomes even more challenging when an existing surface is to be changed to a wireless charging surface without changing the original purpose of the surface.

In prior art solutions, the receiver, which is connected to a mobile phone, is placed on a powering mat. The mat lies on a table. When the receiver is close enough to the mat, magnetic attractive force pulls the receiver to full contact with the mat. However, this does not cause the charging to begin, because it is probable that the receiver is misplaced in relation to the transmitter, which is inside of the mat. The user must thus move the receiver on the mat and search for the correct location for the receiver. Once the correct location has been found, a beep tone can be heard expressing that charging begins.

Moreover, current prior art wireless charging systems are not wireless in reality, because there are still wires within the user's reach. When wireless charging takes place by means of the powering mat or a charging plate, the charging event is tightly place-related, because the mat or the plate is connected to the mains by an electric conductor. Hence an energy transmitter element, an identification element or both that enable wireless charging in prior art solutions are still connected to the mains by a wire and therefore they do not support comprehensive wireless power transmission and charging.

### BRIEF DESCRIPTION DISCLOSURE OF THE INVENTION

An object of the present invention is to provide a method and an apparatus for implementing the method so as to solve the above problems. The objects of the invention are achieved by a method and an arrangement, which are characterized by what is stated in the independent claims. The preferred embodiments of the invention are disclosed in the dependent claims.

The invention is based on the idea of accurately signalling the correct location for the receiver. An advantage of the method and arrangement of the invention is that the charging is efficient and that the charging begins immediately.

### BRIEF DESCRIPTION OF THE DRAWINGS

In the following the invention will be described in greater detail by means of preferred embodiments with reference to the attached drawings, in which

FIG. 1 shows an indication element according to the invention and is embodiments;

FIG. 2 shows the indication element according to the invention and is embodiments;

FIG. 3 shows an arrangement of the invention and its embodiments;

FIG. 4 shows an arrangement of the invention and its embodiments;

FIG. 5 shows an arrangement of the invention and its embodiments;

FIG. 6 shows an arrangement of the invention and its embodiments;

FIG. 7 shows an arrangement of the invention and its embodiments; and

FIG. 8 shows an induction charger stick of the invention and its embodiments.

### DETAILED DESCRIPTION OF THE INVENTION

In an inductive energy transfer arrangement, energy is transferred by a magnetic field in such a way that a high-frequency first current supplied to a charging coil generates a changing magnetic field, which induces an alternating second current in a receiver coil. A receiver with the receiver coil, can be in a terminal device or in contact with the terminal device or in communication with the terminal device, and can thus be used for using the terminal device and/or for charging the terminal device or for loading the batteries of the terminal device or apparatus. The receiver coil can also be in a terminal device or in contact with the terminal device or in communication with the terminal device. The created magnetic field can be spherical, and the receiver should find this field in order to be charged or forwarding the charging energy.

The invention and its embodiments provide an indication device for efficient wireless charging. The indication device can be e.g. a charger stick or an indication sticker or their combination. The indication device can comprise means for receiving magnetic energy or other form of energy, means for transforming said received energy into light or other information and means for showing light. The indication device can show a location and/or an occasion and/or a period for efficient charging. Furthermore, according to the invention and its embodiments, it is now simple and easy to change existing or new surfaces such that they can provide efficient wireless charging without changing the original purpose of the surface. E.g. a table is used to hold objects at a convenient height for use and for work using horizontal surfaces above the ground, or to store things.

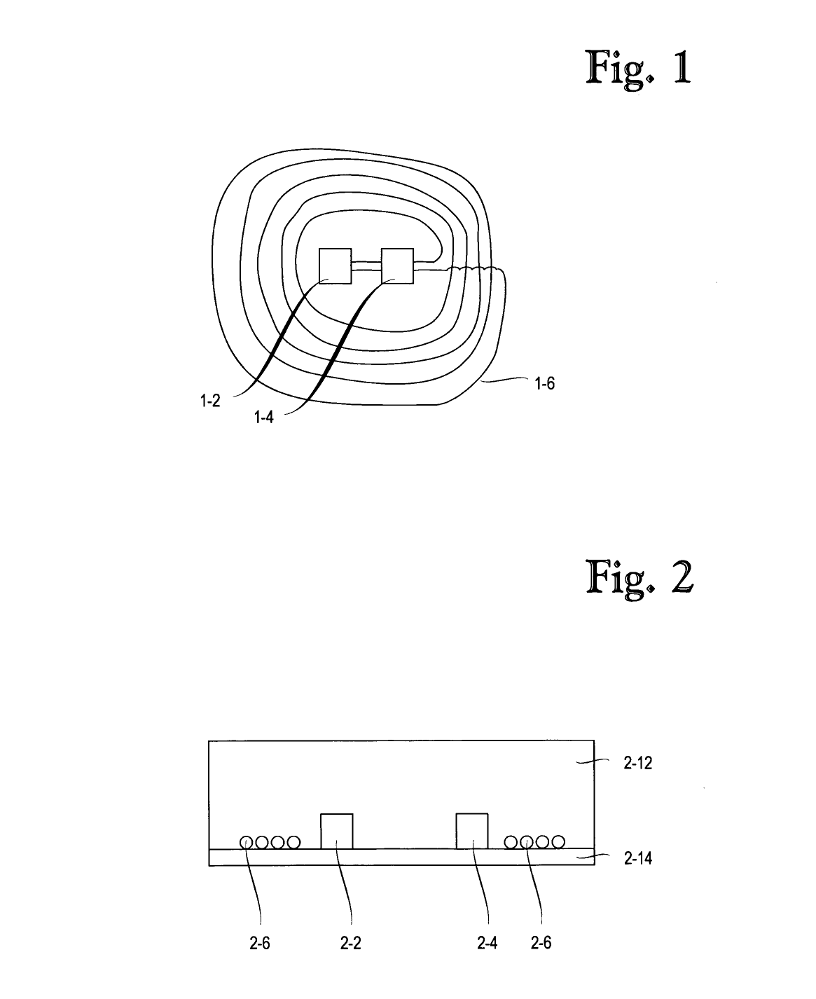

FIG. 1 shows from above a signalization sticker according to the invention and is embodiments. It comprises an Inductive coil 1-6, which reacts for the magnetic energy from the energy transmitter and receives energy as high frequency alternating voltage pulses from the transmitter. The coil can be spiral or to-and-from formed. It can also be in two or more layers. There can also be a resonance capacitor in series with the coil. A power coupling element 1-4, which can be e.g. a rectifier, can transform the energy from the high frequency alternating current and from the coil to direct current or to another form which a light source element 1-2 can use. Also alternating current or both of them can be used. Alternating current and direct current can also be used in series or alternately. The light source is connected to the power coupling element. The light source can be a led (light emitting diode) component or an electroluminent component, e.g. an electroluminent foil or an electroluminescent foil. The foil can be rollable, flexible and cuttable. An inverter, a driver, a filter, and/or a capacitor can be added to the direct current side or such that the light source receives correct voltage, frequency, and other operational conditions.

The sticker can be integrated or it can comprise one or more separate components. The integration can be e.g. into silicon flex material.

The diameter of the device can be 100 mm and the thickness of the device can be about 0.025 mm; 0.036 mm; 0.050 mm; 0.1 mm; 0.6 mm; 1 mm; 25 mm; 50 mm; or bigger.

FIG. 2 shows the signalization charger sticker according to the invention and is embodiments. FIG. 2 is a side figure of the sticker. It shows the light source 2-2, the power coupling element 1-4, and coils 2-6. The device can be made in a protective matter e.g. with a resin. In addition or instead of this, different plastic materials or resistive materials can be used, which can also resist wear and/or erosion. An adhesive layer can be placed to at least part of the base material or resin. The layer or layers is/are for mounting of the device. There can also be a protective layer on the adhesive layer, which protective layer is removed when the sticker is to be attached to a loading surface, e.g. to a surface of a table. Also other mounting methods can be used. The sticker or other indication device can also be placed to the mobile phone.

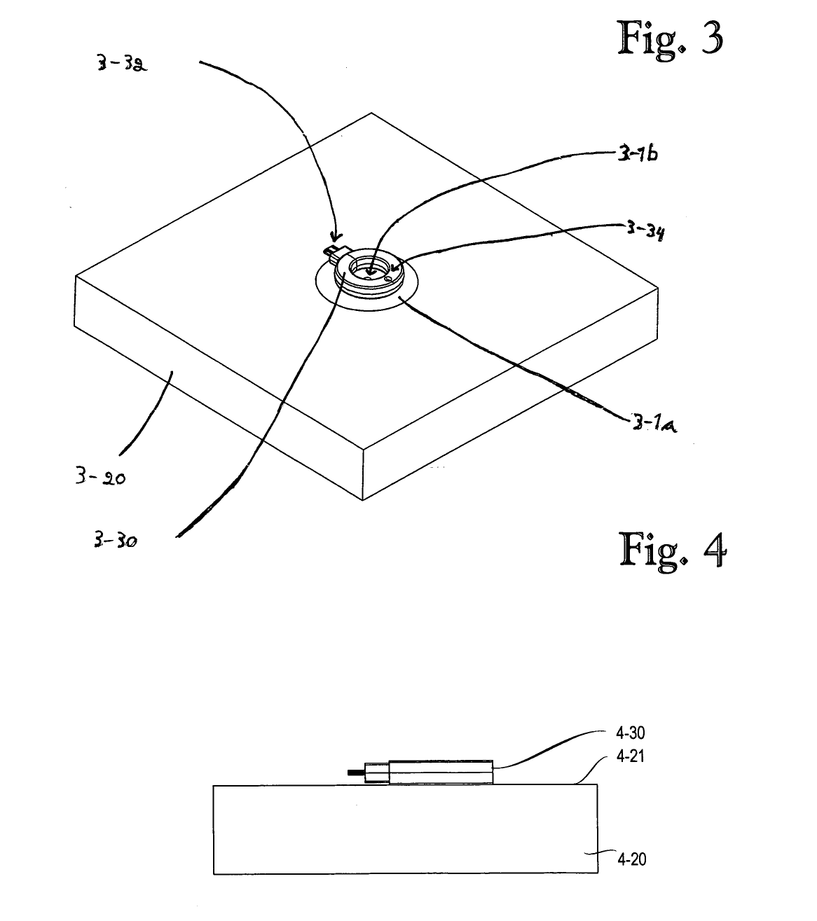

FIG. 3 shows an arrangement of the invention and its embodiments. The receiver 3-30 is resting on the loading surface 3-20. In FIG. 3 the receiver is placed on the table 3-20. If the receiver or the charger stick is of a ring-shaped form or another form having at least one opening or having a transparent area, its centre or the opening or the area can provide an optically unrestricted area and can thus provide a frame for or an interface for directing to another object and/or for accurate signalization of an effective area on the table.

The receiver can be plugged into the device to be loaded and the device with the receiver is positioned to a certain area of the surface. The positioning of the receiver and/or the combination of the portable device and the energy receiver can be guided by different methods, apparatuses and arrangements e.g. for providing efficient charging or loading of a portable apparatus and for providing efficient charger arrangement. The positioning of the device with the receiver is easy, because one can see the point 3-1b through the opening of the receiver. The point 3-1b can be the light source element of the sticker or a light source element of the table or another light source element. The indication device can comprise two or more devices, like the light source element on the table and/or in the sticker and another light source element in the stick, and phases.

Moreover, FIG. 3 shows the arrangement of the device of active wireless signalization light for magnetic field and a charger receiver. Here, the device is the sticker device but it can also be e.g. an adhesive label or a decal or a foil, or an electrical component capable of receiving magnetic energy and changing the received energy to a signal for the user to sense the correct position of the receiver only by using this first signal or by also using another, second signal or only by using the second signal, which second signal can signal in response to the first signal. For this sensing the receiver can have one or more indicating elements on and/or in the receiver. In FIG. 3 a light emitting diode 3-34 is shown, but it can also be a tone generating element or other e.g. a tactile generating element.

In or near the centre of the sticker, there can be a positioning point. This point can show, where to put the receiver. The receiver can be positioned e.g. such that the point is at the centre of the opening of the receiver. The positioning point can be part of the sticker or it can be a separate led component or other electrical component e.g. on the table or in another sticker.

The sticker 3-1a can function such that the sticker shows one or more different states of the loading. When there is no receiver present on the table, the transmitter of energy turns on occasionally and sends magnetic energy. The coils of the sticker receive the transmitted energy, and the received energy powers the light source of the sticker. Alternatively, they can power the led of another sticker or the led in the table. The led can illuminate for a short period, continuously and/or with dim light and/or with a first light this phase. The led can light more than one colour or one led for one colour can be used. This can be seen by the user, and this directs the user of a mobile device with the receiver to position the receiver to a correct place. When the receiver is placed on the sticker, the charging can begin. The charging phase can be seen from the sticker and/or from the centre or through the centre and/or from the led of the receiver. The led can illuminate for a short period, continuously and/or with bright light and/or with a second light this phase. When the charging is finished, the led can illuminate for a short period, continuously and/or with dim or even a brighter light and/or with a third light to show this third phase. If the charging is prohibited or with a error situation, the led can illuminate for a short period, continuously and/or with dim light and/or with a fourth light.

In addition to or instead of the wireless charging, data can be communicated from the transmitter to the receiver or vice versa and/or between them. This communication can also be shown with different lights.

The receiver can also have different plugs 3-32 for it to be connected to different mobile apparatuses, e.g. to mobile phones of different manufacturers. Different receivers can have different plugs. Alternatively, one receiver can have one or more different plugs.

The diameter of the base portion of a ring-shaped stick is about 38 mm and the diameter of the opening is about 25 mm. The diameter of a circular-shaped sticker can be about 45 or 60 mm. Also other sizes can be used.

The sticker can be of circular or of a square form or e.g. a form of an even-armed cross, and the stick can be of an oblong or elongated form or of a circular form. Also other forms are possible. One or more openings can be provided to both of them. The stick and the sticker can be of different materials and they can be coated with different materials. They can also be at least partly transparent e.g. for location purposes. The stick and the sticker can comprise one or more parts. The functions of the stick and the sticker can be divided between these parts. It is important for the sticker that is can receive energy signals and in response to said receiving create an indication signal for indicating the correct location for the receiver. It is important for the stick that it can receive energy signals and in response thereto change the received signal into electrical energy and transfer said energy to an apparatus connected to the stick.

FIG. 4 shows an arrangement according to the invention and its embodiments. It is a side view of FIG. 3. The receiver 4-30 is placed on a surface 4-31 of a furniture, e.g. on the table 4-20. In FIG. 4, the receiver is at least partly in contact to the surface, but it is also possible that the receiver is not in contact to the surface but that it is near the surface. In this situation it can receive magnetic field and energy from the transmitter.

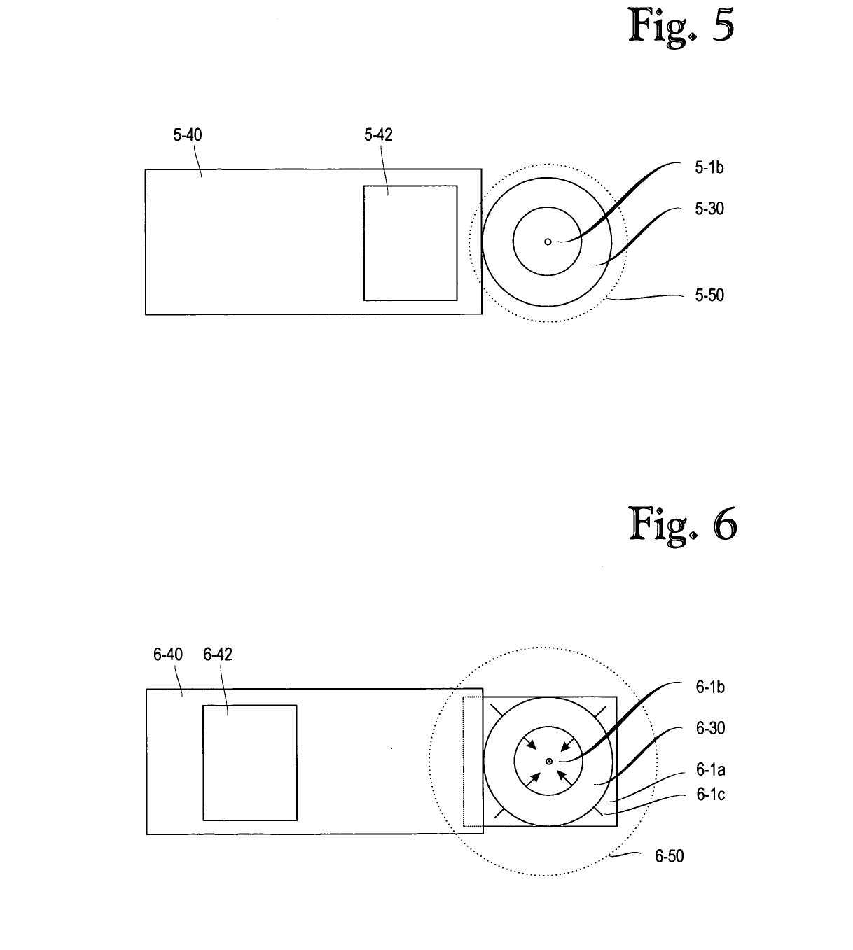

FIG. 5 shows an arrangement according to the invention and its embodiments. A device to be loaded e.g. a mobile phone 5-40 is lying on a loading surface, e.g. on the table. The mobile phone is connected to the ring-shaped receiver 5-30 or to a charger stick or to other charger element. The receiver is placed such that an indication element, e.g. a led 5-1b, is about in the centre of the opening of the receiver. This provides effective charging. Although the indication element indicates the centre of the charging area, the effective charging area can extend from a specific point or from the centre to a larger area 5-50, which can used in loading the device. The position of the indication element can be in the surface or on the surface. The indication element and/or a display terminal 5-42 of the mobile phone can show the status of the charging. There can also exist more than one indication elements e.g. for more accurate indication or for conveying information.

FIG. 6 shows an arrangement according to the invention and its embodiments. The mobile phone 6-40 is connected to the ring-shaped receiver 6-30, which is placed such that the indication element, e.g. the led 6-1b, is about in the centre of the opening of the receiver. The charging area and/or the centre of the charging area and/or the boundaries 6-50 of the effective charging area can be shown by one or more indication elements, light sources and/or stickers 6-1a. The sticker can have passive and/or active pointing components 6-1c, which can direct the receiver to a correct location or to en effective location for charging. All or part of the sticker can be illuminated by inductive coil, power coupling and light source components to show the phase of the charging process and/or for showing the accurate location for the receiver. The indication element and/or the display terminal 6-42 of the mobile phone can show the status of the charging.

The receiver 6-30 can be attached to the mobile device via an interface. The interface can be in different sides of the mobile device. Alternatively the receiver can be integrated to the mobile device or it can be as a separate component in, on, or in connection to the mobile device. The receiver can be e.g. in a shell or cover of the mobile device.

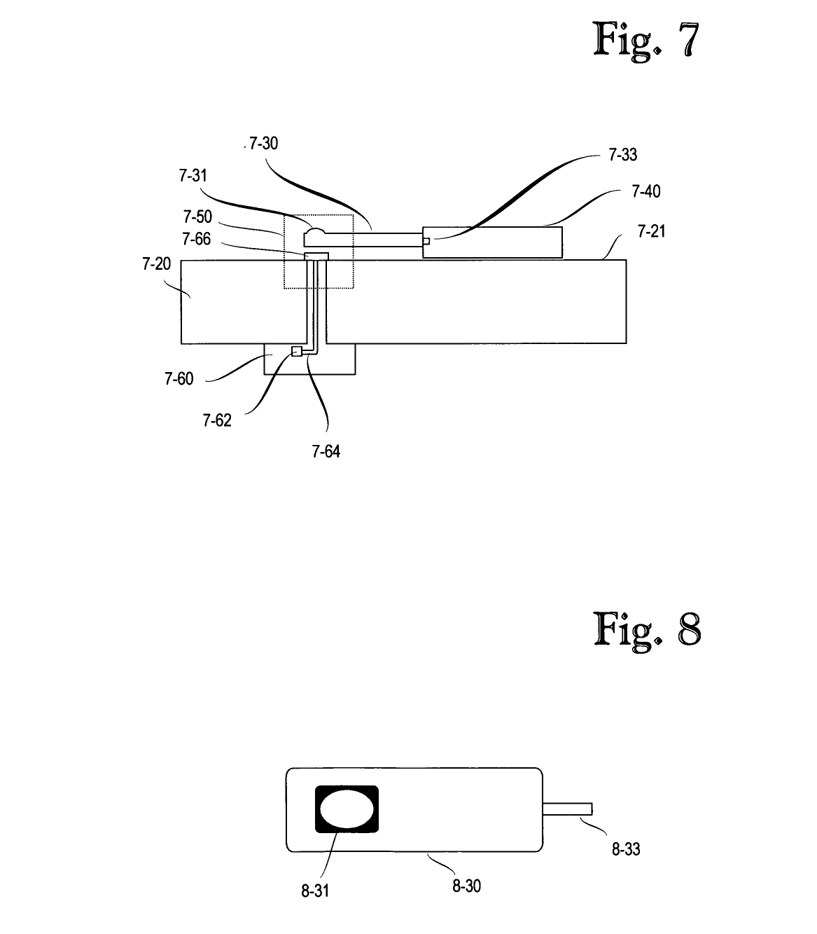

FIG. 7 shows an arrangement according to the invention and its embodiments. A mobile phone 7-40 is placed on the first energy surface 7-21, which is the table 7-20 in FIG. 7. The receiver stick 7-30 is connected to the mobile phone with the interface, being the plug 7-33, which the mobile phone can receive.

The transmitter of energy 7-60 creates or generates an energy field, e.g. the magnetic field 7-50. The mobile phone can freely be placed to the table within the area of this magnetic field. If there exists more transmitters, the area for charging increases. It is to be noted that if the area is small the positioning is even more important and more accurate positioning is required for receiving magnetic energy for wireless charging.

The charging area for the mobile phone can be indicated such that an indication device is placed within the charging area. The indication device can be e.g. on the table, in the table or in the stick. The stick can have receiving means for receiving magnetic energy and in response to said receiving the indication elements of the stick can illuminate and show the correct location, i.e. when the stick is illuminated, it shows the efficient area. In the indication element, the indication can be a light, a tone, a form, a signal, a haptic element, a tactile element, a semi-tactile element or an element using one or more different senses or their combination. In FIG. 7 the indication element, which indicates the charging area, can comprise a led (light emitting diode) 7-62 element and a lens element 7-66 or only one of them. The lens element can be supplied by an optical fibre or a light guide 7-64 from the light source element 7-62. Above the led a crystal or a crystal plug or said lens 7-66 can be placed for shielding purposes and/or for more accurately distributing the light.

In FIG. 7 the indication element can be in the stick 7-30 and/or in the table 7-62 and/or above the table 7-66. Magnetic energy can be received by the components connected to the led 7-62 or by the components, e.g. coils in the stick. The receiver, e.g. a ring-shaped receiver, can use the information on the indication device and it can be positioned such that it receives efficiently magnetic power for wireless charging.

The stick can comprise an indication part 7-31 in the centre of the stick or near the edge of the stick. It is possible that the stick has an opening or one or more transparent parts through which the light can be detected. The indication part can receive light from the led and forward the light either unchanged or changed. The indication part can have a spherical form for more accurately distributing the light.

There exist many different arrangements and methods for indicating the correct or efficient location for charging. In FIG. 7 there is a through hole in the energy surface. It is also possible to have a blind hole or no hole or a rise or elevation on the surface. In all cases the furniture can be used for its original purpose or the purpose it was originally designed or for also another purpose than charging.

In the invention and its embodiments the transmitting coils transmits magnetic energy in the first phase, and a magnetic field and an electrical field resonate. The transmission can be on a resonance frequency. The frequency can be predetermined or it can be changed. The frequency can be generated by a resonator, e.g. by a LC-resonator. The sticker or the indication device receives this magnetic energy in the second phase. Also the power receiver stick receives this energy. The receiving frequencies or the receiving resonance frequencies of the sticker and the stick can be such implemented that the sticker receives only a part of the transmitted energy and the stick receives full energy. The resonance frequency can be determined by the resonator in the sticker and in the stick, e.g. by the LC-resonator. Then, in the third phase a determination can be made. It can be calculated or decided, whether the energy or the transformed energy received by the sticker overcomes a first threshold level. If this is not the situation, no light is set. In the fourth phase, if the threshold level is overcome, a first light is set. This first light can be e.g. a white light indicating a standby charging state. The energy transmitter can continue to transmit a polling signal. When the terminal apparatus is put on the loading surface, the transmitter detects this and can start the loading. In it the transmitter increase the transmission power and more energy and power is transmitted in the fifth phase, causing the received energy level in the indication device to overcome the second threshold level. In this phase, a second light is set being e.g. a red light. During the loading, the transmitter in the sixth phase observes or detects a status or a loading status of the receiver stick and/or the apparatus to be loaded. When the charging is ready and/or the battery is full loaded, the transmitter decreases the transmission power, and a third light can be set being e.g. a green light in the seventh phase. It is also possible to switch the light on and off for specific purposes. However, in this situation also the charging is switched on and off. Different colours of light can be in response to different currents induced to receiving means of the indication device or by transforming magnetic energy into light with different wavelengths according to variation of power of received magnetic energy.

FIG. 8 shows an induction charger stick according to the invention and its embodiments. Said receiver comprises a base portion 8-30 and a plug portion or an adapter 8-33. The base portion can comprise one or more indicators 8-31, which can indicate that the correct location for charging has been found and/or the charging is about to begin and/or the charging is processed and/or the full charge exist. The indicator can have different shapes and sizes like a spherical shape or a dome-like shape. The indicator can also be at least partly transparent or of material which can transmit light and/or a form of a visual figure or a sign. The indicator(s) can be placed on the same or different sides of the stick. The indicator can also be an opening in the stick. If the opening is not positioned symmetrically, the base portion, when cut, has two surface areas or shearing areas of different sizes. When the stick of FIG. 8 is plugged into the interface of the mobile phone and said combination is put on the surface, the stick can be above the surface. In another embodiment, the stick can be in contact to said surface.

An adapter compatible with the wireless charging system may be small, and the adapter or a part thereof may have a shape conforming to that of the electrical device, or a standard shape. The adapter may be connected to the electrical circuit of the electrical device through e.g. a charging plug, a USB (Universal Serial Bus) connector, FireWire connector (IEEE 1394), directly to the circuit board, or by some other means. In FIG. 8b the adapter 8B-2 or a part thereof is flat and possibly self-adhesive, and it may be attached to the charging plug 8B-6 of the electrical device 8B-4 or to the charging plug 8B-6 of its battery, for example. In FIG. 8c the adapter 8C-2 or a part thereof has a standard rectangular, round or planar shape and it may be connected to the charging plug 8C-6 of the electrical device 8C-4 or to the charging plug 8C-6 of its battery, for example. In FIG. 8d the adapter 8D-2 or a part thereof has a substantially planar and/or longitudinal shape and may be connected, together with the electrical device, to a charging plug 8D-6 by one or more counter pieces 8D-8. In addition, the adapter may be placed within the terminal device and connected to an interface between the terminal device and the battery, for example, or to some electrically suitable connection, interface or port.

In one example the width of the plug portion is about 24 mm and the depth of the plug portion is about 5 mm. The length of the base portion can be e.g. about 30 mm or about 46 mm and the width can be e.g. about 10 mm.

Inductive charging uses a magnetic field to transmit energy. Because charging works only at a limited area around a transmitter, there exists a clear need to signal the location and/or the strength of the magnetic field. This can be achieved by the arrangement of the invention and its embodiments.

In one embodiment, the signalization of charging area can be done by the led, which requires one or more holes in charging applications, for example in furnitures. The hole is for wires or only for a light cable.

In another embodiment inductively powered signalization light is used where no holes is made to the loading surface. In this embodiment a coil of the indication sticker receives a voltage proportional to the strength of the magnetic field. The voltage causes the light source of the sticker to emit light. Changes in voltage cause light to alter its intensity and/or colour. Therefore the magnitude of magnetic field can be sensed as colour and/or as the intensity of the emitted light. The colour of light and/or its intensity can direct to the effective charging area. In other words, the functional area of the wireless charger can be marked by the inductively powered signalization light. During charging, the light can change. Therefore user finds the active area and knows, when mobile device is at accurate location for charging.

In wireless charging a power surface is provided comprising one or more energy transfer units or transmitters by means of which charging current may be supplied to one or more terminal devices or receivers. It is important in wireless charging that a transmitter of energy and a receiver of energy are not misplaced in relation to each other. In other words, the surface, such as the surface of a furnishing element or a furnishing element, such as a table, shelf, surface or other planar furnishing element can be provided with charging coils.

The invention and the preferred embodiments thereof allow commonly used everyday surfaces and furnishing elements, for example, to be renewed. This may be achieved for example by incorporating wireless charging systems into everyday furnishing elements without determining, however, other uses of the product. It is also possible to add systems later to already manufactured products. For example, a manufacturer of a table may implement solutions of the invention or a preferred embodiment thereof into a table or in the vicinity thereof either during the manufacturing phase of the table or when the table has been finished. The surface of furnishing elements may be provided with transmitters based on electromagnetic induction, for example, that transmit electric power to electrical devices in their vicinity. The furnishing element may communicate with the devices to be recharged over the commonly known RFID technology, for example, which allows the charger to transmit power only a in situation, where an electrical device or a device having a specific identifier or priority, for example, and requiring current is in the vicinity. Alternatively, the need for current may be determined automatically by connecting charging current to the primary coil, in which case a change in the current allows to deduce whether there is a device needing current in the vicinity.

The furnishing element may be connected directly either to ordinary mains current by a standard electric plug or also to a wireless system via a floor, wall or ceiling, for example, in which the system comprises two or more power surfaces. The first one may be a table or other furniture and the second one may be a floor. The first and the second power surfaces may be interconnected by e.g. an elongated vertical element for transferring power from one surface to another. The terminal device may be a mobile phone.

The first power surface may comprise an identification element or elements for detecting a terminal device on the power surface or in the vicinity thereof, for processing this detection event, for determining the charging need of the terminal device and for communicating this information to one or more induction loops or other arrangements, and one or more induction loops or other arrangements for producing charging current for the terminal device.

The terminal device adapted to the system may comprise one or more identification elements, induction loops or other arrangements and an element, such as an accumulator or battery, for receiving and storing electrical energy.

Transceivers, such as RFID transceivers, may be used for communicating with electrical devices, and a transmitter guiding the control electronics to supply charging current to coils in the vicinity of the electrical device. A transceiver, such as the RFID transceiver, in the terminal device or in connection therewith may communicate with the power transfer surface on the charging need of the terminal device. The charging current may be produced by one or more chopper power sources, for example.

An energy transfer arrangement can comprise a first energy surface and first means for transferring energy from the first energy surface to a terminal device. The terminal device may be freely placed in relation to the first energy surface and the first energy surface may be freely placed in relation to the second energy surface. The system also comprises second means for transferring energy from the second energy surface to the first energy surface.

According to the above, the surfaces may also be used for another purpose different from their ordinary purpose of use. Hence a floor, for example, which is usually to be walked on, may be used for charging a table. The table, which is primarily used e.g. in mealtimes, for furnishing, as a piece of furniture, as an item of interior decoration may be used for charging a terminal device. In other words, an ordinary piece of furniture, furnishing element or surface may also be used for a new purpose.

The charging furnishing element may comprise e.g. a surface or recess of a planar or some other shape, primary coils installed underneath or onto the surface, a power source, an RFID receiver, control electronics, a coupling to an electrical network or a connection to another wireless charging system.

The elements needed for changing the charging event may be placed either indoors or outdoors or for example inside a vehicle, such as a ship, car, airplane, train or rocket, or integrated into the structure thereof. One or more elements may be arranged outside the structure, inside the structure or integrated therein. From the user's point of view the charging takes place simply by placing the product, such as a mobile phone, computer, camera, mp3 player, torch or weapon to the vicinity of an ordinary, commonly used furnishing element, whereby the battery becomes automatically charged to its full extent. The furnishing element is water-proof to the extent allowed by the materials of the elements. A charging floor may be placed into any indoor or outdoor premises or for example within a car, ship, train or airplane.

The invention and the preferred embodiments thereof may operate partly or completely automatically. The furnishing element and/or the indication element consume energy only as much as needed, which means that energy consumption is efficient and independent of the user. Chargers meant for charging prior art network equipment consume a lot of energy when attached to the mains current but detached from the device. The devices are also capable of switching off itself automatically.

A further advantage of the invention and the preferred embodiments thereof is that all phases of the charging event may be incorporated into other objects also in ordinary use, and according to a preferred embodiment, access thereto is not restricted to products meant for charging alone, although they may contain also these products. A fully wireless and fully automated system of charging electrical devices on the basis of electromagnetic induction or the like may be implemented as described above. The system renders wireless charging of electrical devices independent of the location of plugs in the space concerned and makes the charging efficient.

According to the invention and its embodiments, there is implemented a comprehensive wireless power transfer and a furnishing element based on electromagnetic induction or other arrangement that enables a completely wireless charging system. According to a preferred embodiment the transmitter element enabling the wireless charging and the identifying element are both wireless, the new constructional solutions enabling fully wireless charging.

The invention may use resonant coupling to enable a longer charging distance.

The invention and its embodiments are not restricted to a particular method of use, user, terminal device, number of energy transfer surfaces, shape, size, weight, outer appearance, structure, attachment mechanism, arrangement, integration, distance or reciprocal location etc., furnishing element, energy transfer surface, method of user or equipment identification, energy transfer method, power transfer method or charging method.

Consequently, the terminal device may be a device, such as a mobile station, communicator, navigator, toy, household apparatus, handicraft tool, computer, camera, musical device, hygiene device, therapeutic device, lighting fixture, lamp or toothbrush, that requires and/or stores e.g. electric energy, electric power, and the user may be e.g. a person or another device. As described above, the second energy transfer surface may be a floor, carpet, laminate, wall, wallpaper, ceiling, suspended element, growing element. The shape, size, weight, outer appearance, structure, attachment, arrangement, integration etc. of the surface or the surface and the structure supporting it may vary. Part of the surface may be underneath or within another surface.

The second energy transfer surface may be completely or partly identical with the first energy transfer surface. In addition, the first energy transfer may be a piece of furniture, furnishing element, structural element or auxiliary element. At least part of the first and/or second energy transfer surface may be reduced or enlarged by placing the surface within the other or another surface or by retrieving it therefrom, or by building a larger surface from smaller surface parts.

The second energy transfer surface is movable on the first energy surface, or the first energy surface is movable on the second energy surface. The second energy surface is freely movable on the first energy surface and/or the first energy surface is freely movable on the second energy surface. In addition, the terminal device is freely movable on the first and/or second energy surface. In one embodiment, the first and the second energy surfaces are not in direct contact with one another. One or more of the surfaces or parts thereof may be wireless or wired. Furthermore, the first or the second energy surface or a part thereof can be substantially planar or banded.

The identification of the one or more energy transfer surfaces, users or devices may take place on the basis of the frequency, amplitude or phase of the signal of identification or use. Alternatively, the one or more energy transfer surfaces or users do not need to be identified, but charging may be continuous and automated, or may take place at specific intervals. Energy transfer may be carried out by means of radio or micro waves, laser beam or electromagnetic induction, for example.

According to the invention and its embodiments, it is provided charger arrangement to the existing surface, e.g. to the existing table without changing the original purpose of the surface or the table. The arrangement can be of optical nature, which resembles the behaviour of a human being as far as possible. It can be said that the arrangement forms an optical sight, which is easy and effective to use.

The invention and its embodiments provides many advantages. The transmitter and the receiver can be accurately directed near to each other such that when the user puts the mobile phone on the surface of the table, the correct location for the mobile phone with the receiver is immediately found and the charging is efficient and most optimal. According to the invention and its embodiments the direction or the alignment or the adjustment is accurate also in case of a large surface like a table in which case it is possible that the user does not even realize that attention should be paid to the alignment but puts the mobile phone randomly to the table. Another advantage is that interface between the transmitter and the charging area is now optimal for the effective charging. Also an immediate response can now be signalled to the user. The signalling can comprise one or more signals with data or information on the status of the charging state of the mobile phone or on the efficiency of the charging or of different states or phases during the charging. This can be e.g. in response to the start of the charging. The user does not have to move the mobile phone and search for the correct location or to check whether the charging has begun. Instead different signals can be transmitted describing e.g. whether the charging has begun or whether the charging is ready. Also other information and data can be signalled. Thus, the immediate and correct response increases the efficiency of the charging, because e.g. the distance between the receiver and the charging area stays unchanged.

It will be obvious to a person skilled in the art that, as the technology advances, the inventive concept can be implemented in various ways. The invention and its embodiments are not limited to the examples described above but may vary within the scope of the claims.

1. An indication device comprising
means for receiving magnetic energy; and
means for transforming said received magnetic energy into light.

2. An indication device according to claim 1, wherein transforming magnetic energy into light with different wavelengths according to variation of power of received magnetic energy.

3. An indication device, according to claim 1, wherein said receiving means comprises an induction coil and in that said transforming means comprises a power coupling element and one or more light source components.

4. An indication device according to claim 3, wherein the induction coil, the light source component and the power coupling element are placed in resin, and at least part of the resin is covered by an adhesive component for mounting the indication device to a charging surface via which magnetic energy is received.

5. An indication device according to claim 3, wherein the light source component is a light emitting diode or an electroluminent foil.

6. An indication device according to claim 1, wherein the indication device is a sticker, which receives magnetic energy and transforms it into light for conveying the information on the effective charging area.

7. An indication device according to claim 1, wherein the indication device is a led, which receives current in response to received magnetic energy and transforms it into light for conveying the information on the effective charging area.

8. An arrangement for a charger, wherein it comprises:
a transmitting device for transmitting magnetic energy to be used for charging a mobile apparatus;
an indication device according to claim 1 for receiving magnetic energy or current in response to received magnetic energy and for indicating an area in which the mobile apparatus can be charged.

9. A charging method, comprising:
receiving magnetic energy;
transforming said received magnetic energy into light; and
showing light for indicating an area to which a receiver can be positioned for charging a mobile apparatus via the receiver.
